(19) United States
(12) Patent Application Publication
(10) Pub. No.: US 2010/0163215 A1
(43) Pub. Date: Jul. 1, 2010

(54) DUAL VOLUTE ELECTRIC PUMP, COOLING SYSTEM AND PUMP ASSEMBLY METHOD

(75) Inventors: Bin Li, Dunlap, IL (US); Tony R. Metzger, Congerville, IL (US); Michael D. Betz, Knoxville, IL (US); Quenton R. Dunn, Wylie, TX (US); Jeremy Carlson, Janesville, WI (US); John Culliton, Escanaba, MI (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc., Peoria, IL (US)

(21) Appl. No.: 12/435,605

(22) Filed: May 5, 2009

Related U.S. Application Data
(60) Provisional application No. 61/203,864, filed on Dec. 30, 2008.

(51) Int. Cl. H02K 9/00; F04D 13/06; F04D 29/046; B23P 11/00

(52) U.S. Cl. 165/120; 417/423.14; 417/423.12; 29/888.025

(57) ABSTRACT

An electrically powered pump for a cooling system in a machine such as an electric drive track-type tractor includes a pump housing having a first volute and a second volute, each including a different cooling circuit segment. A drive assembly including an electric motor and a pump shaft is positioned within the pump housing, and a first impeller and a second impeller are mounted on the pump shaft at first and second axial locations on opposite sides of a rotor of the electric motor. The first impeller has a first impeller configuration, and defines a first tolerance sensitivity with the first volute, and a second impeller has a second, different impeller configuration and defines a second, lesser tolerance sensitivity with the second volute. The first impeller may include au open impeller positioned at a first clearance with the first volute, and the second impeller may include a closed impeller positioned at a second, greater clearance with the second volute.

This Application claims the benefit of the filing date of U.S. Provisional Patent Application Ser. No. 61/203,864, filed Dec. 30, 2008.

### TECHNICAL FIELD

The present disclosure relates generally to machine cooling systems and cooling system components, and relates more particularly to a dual volute electrically powered pump for a machine cooling system having two impellers for pumping fluid through two different cooling circuits.

### BACKGROUND

Internal combustion engines are commonly equipped with engine-driven pumps to circulate a coolant such as water or water glycol mixtures through portions of the engine housing. A belt or geartrain is conventionally used to power the pump via an engine flywheel. Such systems are well known and have been widely used for many years. Conventional designs nevertheless have various shortcomings.

Certain machines, notably heavy-duty construction and earth moving machines, may be operated in environments having significant airborne debris. In such instances, debris can interfere with smooth and efficient operation of belt driven and gear-driven pumps, reducing component service life or requiring frequent maintenance. In addition, certain modern machine systems have heat rejection requirements for their internal combustion engines that are difficult to satisfy with conventional sized and conventionally powered coolant pumps. In some cases, subsystems in addition to the internal combustion engine may be best cooled via liquid, increasing the burden on the pump in conventional single pump designs. The impracticality of using multiple engine-driven pumps due to cost and packaging issues, however, will be readily apparent. Further still, conventional mechanical pumps may be subjected to relatively high torsional loads leading to premature seal or shaft failure. This may be especially problematic where such plumps are used in high pumping volume or high pumping speed applications.

U.S. Pat. No. 3,272,129 to Leopold is directed to a pumping system and pump having two impellers mounted on a common pump shaft. In Leopold's design, rotation of the plump shaft in a first direction pumps fluid via a first impeller while a second impeller passively rotates. When the pump shaft is rotated in an opposite direction, the second impeller pumps fluid while the first impeller passively rotates. Using opposed pumps purportedly allows pumping water into a dishwasher via the first impeller, then, when desired pumping dirty dishwater out of the dishwasher via the second impeller. While Leopold may achieve its stated purposes, the pump is limited in applicability outside the specific context of a reversible pump. The opposition of the impellers means that only one impeller is pumping when the pump shaft is rotated, and thus Leopold would not be capable of simultaneously pumping fluid through separate fluid circuits.

### SUMMARY

In one aspect, an electrically powered pump for a cooling system in a machine includes a pump housing having a first volute that includes a first cooling circuit segment and a second volute that includes a second cooling circuit segment. The pump housing further defines a longitudinal axis, a first fluid inlet to the pump housing and a first fluid outlet from the pump housing each fluidly connecting with the first volute. The pump housing further defines a second fluid inlet to the pump housing and a second fluid outlet from the pump housing each fluidly connecting with the second volute. The electrically powered pump further includes a drive assembly including an electric motor having a stator and a rotor, and a rotatable pump shaft fixed to rotate with the rotor in a pumping direction and defining a longitudinal shaft axis overlapping with the longitudinal housing axis. The stator, rotor and pump shaft have fixed axial positions within the pump housing. A first impeller is disposed in the first cooling circuit segment and mounted to the pump shaft at a first axial location on a first side of the rotor. The first impeller has a first impeller configuration and is rotatable in the pumping direction to transition fluid from the first fluid inlet to the first fluid outlet. A second impeller is disposed in the second cooling circuit segment and mounted to the pump shaft at a second axial location on a second, opposite side of the rotor. The second impeller has a second, different impeller configuration and is rotatable in the pumping direction to transition fluid from the second fluid inlet to the second fluid outlet.

In another aspect, a cooling system for an electric drive machine includes a first cooling fluid circuit having a plurality of cooling circuit segments, and a second cooling fluid circuit fluidly separate from the cooling fluid circuit and including another plurality of cooling circuit segments. The cooling system further includes an electrically powered pump including a pump housing having a first volute that includes a cooling circuit segment of the first cooling fluid circuit and a second volute that includes a cooling circuit segment of the second cooling fluid circuit. The pump housing defines a first fluid inlet to the pump housing and a first fluid outlet from the pump housing each fluidly connecting with the first volute, and a second fluid inlet to the pump housing and a second fluid outlet from the pump housing each fluidly connecting with the second volute. The electrically powered pump further includes a drive assembly having an electric motor and a pump shaft rotatable via the electric motor. A first impeller is mounted to the pump shaft and has a first impeller configuration, and a second impeller is mounted to the pump shaft and has a second, different impeller configuration.

In still another aspect, a method of assembling an electrically powered pump for a cooling system in a machine includes assembling a pump shaft having a longitudinal shaft axis with a bearing housing that includes a bearing bore therein mid a pump shaft bearing positioned within the bearing bore. The method further includes locating a first impeller having a first impeller configuration at a first axial position on the pump shaft at least in part via contacting a first axial side of the bearing housing with a locating device during pressing the first impeller onto the pump shaft. The method also includes coupling a drive assembly with the pump shaft, including connecting a first axial side of an electrical motor housing of the drive assembly with a second axial side of the bearing housing, and locating a second impeller having a second, different impeller configuration at a second axial position on the pump shaft at least in part via contacting a second axial side of the electrical motor housing with a locating device during pressing the second impeller onto the pump shaft.

In still another aspect, an electrically powered pump for a cooling system in a machine includes a fluid pumping mechanism including a drive assembly having an electric motor and a pump shaft rotatably coupled with the electric motor. The pump shaft includes a first axial end and a second axial end, and the fluid pumping mechanism further includes a first impeller mounted to the pump shaft adjacent the first axial end and a second impeller mounted to the pump shaft adjacent the second axial end. The electrically powered pump also includes a pump housing having an outer surface, a first volute positioned about the first impeller and including a first cooling circuit segment and a second volute positioned about the second impeller and including a second cooling circuit segment. The pump housing further includes a two-piece motor housing which contains the electric motor and is positioned between the first volute and the second volute and arranged coaxially about the pump shaft. The two-piece motor housing includes a first motor housing piece and a second motor housing piece mated with the first motor housing piece and each including a portion of the outer surface of the pump housing. The first motor housing piece includes a first axially inward segment defining a first bearing bore having a first pump shaft journal bearing positioned therein and a first axially outward segment projecting into the first volute and defining a first water seal bore having a first water seal positioned therein. The second motor housing piece includes a second axially inward segment defining a second bearing bore having a second pump shaft journal bearing positioned therein and a second axially outward segment projecting into the second volute and defining a second water seal bore having a second water seal positioned therein.

### BRIEF DESCRIPTION OF THE DRAWINGS

FIG. 1 is a side diagrammatic view of an electric drive machine having a cooling system according to one embodiment;

FIG. 2 is a pictorial view of a dual volute electric pump according to one embodiment;

FIG. 3 is a sectioned side diagrammatic view of the pump of FIG. 2;

FIG. 4 is a sectioned diagrammatic view of a subassembly of the pump of FIGS. 2 and 3, shown at a pump assembly stage;

FIG. 5 is a sectioned side diagrammatic view of another subassembly of the pump of FIGS. 2 and 3, at another pump assembly stage;

FIG. 6 is an elevational view of a first impeller suitable for use with the pump of FIGS. 2 and 3; and

FIG. 7 is an elevational view, partially in cut-away, of a second impeller suitable for use with the pump of FIGS. 2 and 3.

### DETAILED DESCRIPTION

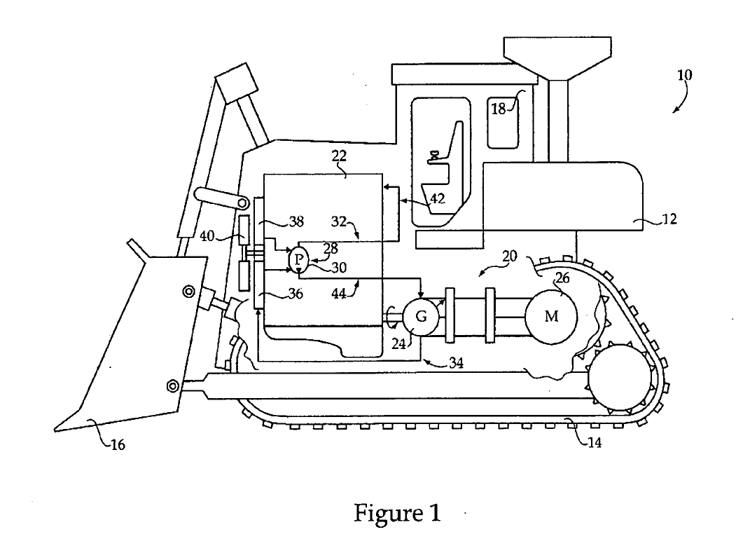

Referring to FIG. 1, there is shown a machine such as a track-type tractor 10, having a frame 12 with a set of tracks 14 coupled therewith, and an implement 16 mounted to frame 12. An operator cab 18 is also mounted on frame 12. Machine 10 further includes a propulsion system 20 having an internal combustion engine 22, such as a compression ignition diesel engine, and a generator 24. Generator 24 may be rotated via internal combustion engine 22 to produce electrical power which powers one or more electric propulsion motors 26. Machine 10 further includes a cooling system 28 uniquely configured for liquid cooling of internal combustion engine 22 and generator 24, as will be further apparent from the following description.

Cooling system 28 may include a first cooling fluid circuit 32 which carries a coolant fluid such as a water glycol mix through a portion of internal combustion engine 22, and thenceforth to a radiator 38. A second cooling fluid circuit 34 carries a coolant fluid through generator 24, and thenceforth to a second radiator 36. FIG. 1 illustrates a first cooling circuit segment 42 of cooling circuit 32 which is an engine cooling circuit segment. A second cooling circuit segment 44, of cooling circuit 34, is a generator cooling circuit segment. In one embodiment, cooling circuits 32 and 34 are fluidly separate, meaning that they include no fluid segments in common. In one embodiment, a temperature of coolant fluid passing through first cooling circuit 32 will tend to be relatively greater than a temperature of coolant fluid passing through second cooling circuit 34. Radiators 38 and 36 may be separate components, although the present disclosure is not thereby limited and mixing of the coolant fluids between cooling circuits 32 and 34 in a common radiator could take place in certain embodiments. A fan 40, driven via internal combustion engine 22, may be provided for passing air across/through radiators 38 and 36.

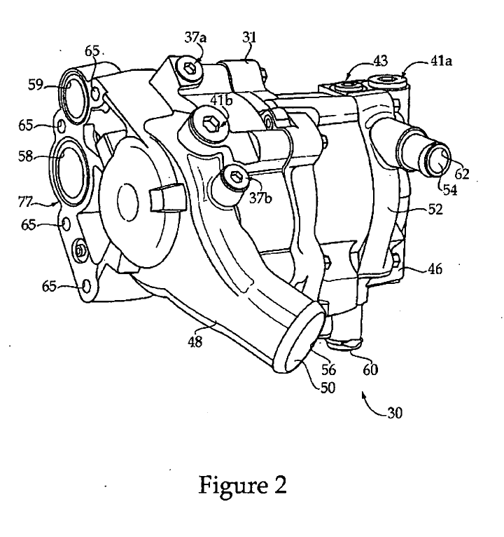

Cooling system 28 may also include an electrically powered pump 30 configured to simultaneously transition fluid through each of cooling circuits 32 and 34. Pump 30 may be electrically driven via electrical power supplied by generator 24. Pump 30 is shown in FIG. 1 positioned at a side of engine 22 for ease of illustration. In a practical implementation strategy, however, pump 30 may be positioned at a front of engine 22 and mounted thereon, or even positioned elsewhere in machine 10. Referring now to FIG. 2, there is shown by way of example another view of electrically powered pump 30. Pump 30 may be a dual volute pump including a pump housing 46 having a first volute 48 that includes a first cooling circuit segment 50. In the illustrated embodiment, cooling circuit segment 50 may be a segment of cooling circuit 32. Pump housing 46 may further include a second volute 52 that includes a second cooling circuit segment 54, which is a segment of cooling circuit 34. Cooling circuit segment 50 may thus fluidly connect with cooling circuit segment 42 and cooling circuit segment 54 may fluidly connect with cooling circuit segment 44. Pump housing 46 also includes an outer surface 31 and may define a first fluid inlet 56 to pump housing 46 and a first fluid outlet 58 from pump housing 46. Each of inlet 56 and outlet 58 fluidly connects with first volute 48. Pump housing 46 may further define a second fluid inlet 60 to pump housing 46 and a second fluid outlet 62 from pump housing 46. Each of inlet 60 and outlet 62 fluidly connects with second volute 52.

Pump 30 may be equipped with certain other features shown in FIG. 2. In one embodiment, pump housing 46 may include a mounting interface 77 for mounting pump 30 to an internal combustion engine housing, such as an engine housing of engine 22, and establishing fluid connections therewith. Mounting interface 77 may include a plurality of bolt holes 65 formed in pump housing 46, and arranged in a predetermined bolt pattern that corresponds with a bolt pattern on the engine housing of engine 22. Fluid outlet 58 may be positioned within mounting interface 77 such that when pump housing 46 is mated with an engine housing, a fluid connection may be made between cooling circuit segment 50 and another cooling circuit segment within the subject engine housing, such as engine cooling circuit segment 42. A bypass inlet 59 may also be provided in mounting interface 77, for connecting with a bypass line or the like in a conventional manner. In one embodiment, a thermostat for one or both of cooling circuits 42 and 44 may be positioned in the bypass line. Pump 30 may further include a heater outlet or outlet connection 37a, and a heater inlet or inlet connection 37b, which connect with first volute 48. In one embodiment, inlet 37a and outlet 37b may be used for circulating hot coolant fluid to operator cab 18 for heating cab 18. An air vent or air vent connection 43 may be provided which connects with second volute 52, and a set of shunt connections 41a and 41b, may connect with volutes 52 and 48, respectively, for connecting a shunt line therebetween.

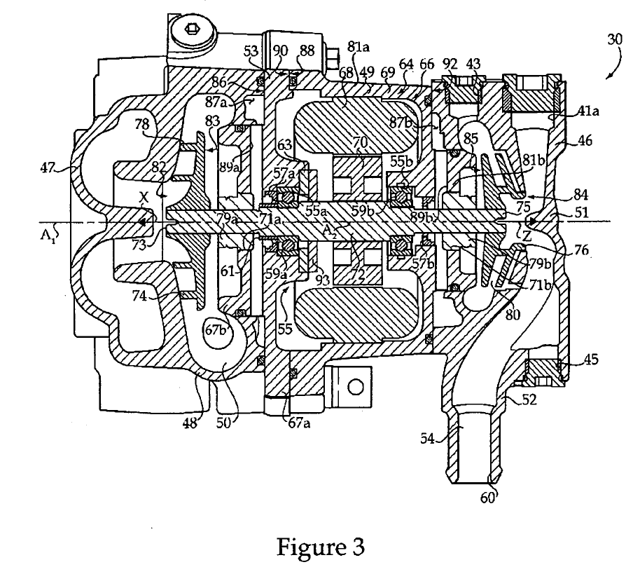

Turning now to FIG. 3 there is shown a sectioned side diagrammatic view of pump 30, illustrating certain internal hardware components and other details. It may be noted that pump housing 46 defines a longitudinal housing axis A₁. A drive assembly 64 including an electric motor 66 is positioned within pump housing 46. Drive assembly 64 may be part of a fluid pumping mechanism 53. Thus, descriptions herein of components of drive assembly 64 may also be understood to describe components which are part of fluid pumping mechanism 53. Electric motor 66 may include a stator 68 and a rotor 70. Drive assembly 64 further includes a pump shaft 72, defining a longitudinal shaft axis A₂ overlapping with longitudinal housing axis A₁. In other words, pump shaft 72 and pump housing 46 may be coaxial. First volute 48 and second volute 52 may also be arranged coaxially about pump shaft 12. Pimp shaft 72 is fixed to rotate with rotor 70 in a pumping direction to simultaneously pump coolant fluid through first volute 48 and second volute 52 in a manner further explained herein. Stator 68, rotor 70 and pump shaft 72 may have fixed axial positions within pump housing 46. In other words, the relative axial positions, along axis A₁ and A₂, of stator 68, rotor 70 and pump shaft 72 are fixed and no or minimal axial movement of any of the components relative to one another will typically take place. It will be appreciated by those skilled in the art, however, that thermal growth of certain of the components, such as thermal growth of pump shaft 72 in an axial direction may occur as pump 30 increases in temperature during start-up, etc. At a predefined temperature, for instance an expected operating temperature for pump 30, stator 68, rotor 70 and pump shaft 72 will remain at fixed axial positions relative to one another.

In the illustrated embodiment, pump housing 46 may be a multiple piece housing. Each of the pump housing portions or housing pieces described herein may include a portion of outer surface 31. A first housing portion 47 is provided which includes first volute 48. A second housing portion 51 is provided which includes second volute 52. A two-piece middle housing portion 49 which contains electric motor 66 is also provided. Middle housing portion 49 may include a first motor housing piece or bearing housing 53 and a second motor housing piece 69. Middle housing portion 49 may be positioned between first volute 48 and second volute 52. Motor housing piece 69 and motor housing piece 53 may be mated together and fluidly sealed. First housing portion 47 and bearing housing 53 may include a first housing material having a relatively lower thermal conductivity and a relatively lower stiffness. Motor housing piece 69 and second housing portion 51 may include a second housing material having a relatively higher thermal conductivity and a relatively higher stiffness. In one embodiment, first housing portion 47 and bearing housing 53 may be cast iron, imparting appropriate strength, and motor housing piece 69 and second housing portion 51 may be aluminum, having relatively better heat conduction to assist in cooling motor 66. Bearing housing 53 may also include a first bearing bore 55a having a first plump shaft bearing or first pump shaft journal bearing 59a positioned therein and rotatably journaling pump shaft 72. A first lip seal 57a may be positioned adjacent first bearing 59a, and may fluidly seal about pump shaft 72 in a conventional manner. A bearing sleeve 61 may be press fit with pump shaft 72, and in cooperation with a retaining ring 63 press fit with bearing housing 53, can axially fix bearing 59a. Motor housing piece 69 may include a second bearing bore 55b having therein a second bearing 59b, rotatably journaling pump shaft 72. A second lip seal 57b may also be positioned in motor housing piece 69 and may seal about pump shaft 72 in a conventional manner. Middle housing portion 49 is thus typically fluidly sealed from volutes 48 and 52. A drain passage (not shown) might be formed in middle housing portion 49 to drain liquid that incidentally enters therein. In the embodiment shown, it may be noted that second bearing 59b has a relatively small clearance in an axial direction with respect to an axially outward end of bearing bore 55b. Second bearing 59b may thus be an axially floating bearing, to accommodate a certain amount of pump shaft thermal growth during operation.

It may further be noted from FIG. 3 that bearing housing 53 includes a first axially inward segment 67a defining bearing bore 55a wherein pump shaft bearing 59a is positioned. Bearing housing 53 further may include a first axially outward segment 67b projecting into first volute 48 and defining a first water seal bore 71a having a first water seal such as a mechanical water seal 79a positioned therein. Motor housing piece 69 may include a second axially inward segment 81a defining bearing bore 55b and having bearing 59b positioned therein. Motor housing piece 69 may also include a second axially outward segment 81b projecting into second volute 52 and defining a second water seal bore 71b having a second water seal 79b positioned therein. Pump housing 46 may still further define a first weep collection chamber 87a located between first volute 48 and bearing housing 53 and a second weep collection chamber 87b located between second volute 52 and second motor housing piece 69. Bearing housing 53 may define a first drain passage 89a communicating between first water seal bore 71a and first weep collection chamber 87a. Motor housing piece 69 may define a second drain passage 81b communicating between second water seal bore 71b and second weep collection chamber 87b.

As mentioned above, rotation of pump shaft 72 in a pumping direction can pump fluid through cooling circuit segments 50 and 54. To this end, pumping mechanism 53 may include a first impeller 74 disposed in cooling circuit segment 50 and mounted to pump shaft 72 within volute 48 at a first axial location on a first side of rotor 70. First impeller 74 may be configured via rotating with pump shaft 72 in the pumping direction to transition fluid from first fluid inlet 56 to first fluid outlet 58. Pumping mechanism 53 may further include a second impeller 76 disposed in second cooling circuit segment 54 and mounted to pump shaft 72 within volute 52 at a second axial location on a second, opposite side of rotor 70. Second impeller 76 may be configured to rotate with pump shaft 72 in the pumping direction to transition fluid from second fluid inlet 60 to second fluid outlet 62. First impeller 74 may have a first impeller configuration. Second impeller 76 may have a second, different impeller configuration. In the embodiments shown, first impeller 74 includes an open impeller, whereas second impeller 76 includes a closed or shielded impeller, the significance of which will be apparent from the following description. The present discussion of first impeller 74 and second impeller 76 having different impeller configurations should be understood to mean that the respective impellers have different shapes.

In one embodiment, first impeller 74 may have an axially outward side 82 and au opposite axially inward side 83. Second impeller 76 may likewise have an axially outward side 84 and an opposite axially inward side 85. When impellers 74 and 76 are rotated in the pumping direction via rotating shaft 72 to pump fluid in their respective cooling circuit segments 50 and 54, they may generate axial thrust loads. In particular, first impeller 74 may define an axial thirst vector X having a first vector direction, and second impeller 76 may define another axial thrust vector Z having a second vector direction opposed to the first vector direction. The first vector direction, corresponding to vector X, may be a first axially outward direction and axial inlet side 82 of first impeller 74 may face the first axially outward direction. The second vector direction may be a second axially outward direction, and axial inlet side 84 of second impeller 76 may face the second axially outward direction. First volute 48 may have a relatively larger volute volume than a volute volume of second volute 52. In addition, first impeller 74 may be relatively larger than second impeller 76, such as by having a larger radial diameter. Each of impellers 74 and 76 will rotate at the same speed as they are each fixed to rotate with pump shaft 72. Nevertheless, the different sizes, and to a certain extent, different impeller configurations, may result in different pumping rates and/or pressure rises in the respective cooling circuit segments 50 and 54. In one embodiment, the pumping rate through first volute 48 may be larger than the pumping rate through second volute 52 by a factor of 5, or even by a factor of 10 or more. Heat dissipation requirements for internal combustion engine 22 may be relatively greater than heat dissipation requirements for generator 24, when implemented in the context of a machine such as machine 10. In other words, it may be desirable to remove a greater total magnitude of heat energy in a given amount of time from engine 22 than from generator 24. In other embodiments, different sizes, configurations and other features of the equipment to be cooled, including placement in machine 10, the use of additional cooling systems such as oil cooling or air cooling etc., may be best addressed through a pump configuration different from that specifically shown and described herein.

In any event, the different impeller configurations and/or different volumetric throughputs through volutes 48 and 52 may result in a net difference between the axial thrust load generated by first impeller 74 and the axial thrust load generated by second impeller 76. In one embodiment, the axial thrust load generated via first impeller 74 will be greater than the axial thrust load generated via second impeller 76. It will be recalled that bearing 59a may be an axially fixed bearing, retained between bearing sleeve 61 and retaining ring 63. Bearing 59a may thus serve not only to rotatably journal pump shaft 72, but may also react axial thrust loads on pump shaft 72. The relatively minor allowance for axial slip or float of bearing 59b will result in bearing 59b rotatably journaling pump shaft 72, but not substantially reacting axial thrust loads on pump shaft 72. An electrical grounding ring 93 may be positioned adjacent retaining ring 63 and axially inward thereof. In one embodiment, electrical grounding ring 93 is fixed relative to pump shaft 72 and forms a rotating electrical connection with pump shaft 72 via bristles or the like which provides a relatively low resistance current path between pump shaft 72 and pump housing 46.

It will further be recalled that each of impeller 74 and impeller 76 are rotating in the same direction. To enable the respective impellers 74 and 76 to each pump fluid when rotated in the same direction, one of impellers 74 and 76 may include a right-handed vane configuration and the other of impellers 74 and 76 may include a left-handed vane configuration. To this end, first impeller 74 may include a plurality of vanes 78 located on axial inlet side 82. Second impeller 76 may likewise include a plurality of vanes 80. Vanes 80 may be internal vanes located between axial inlet side 84 and opposite side 85. The difference in vane configuration may be conceptualized by viewing impellers 74 and 76 as they would appear when viewed from a first axial end 73 of pump shaft 72 and a second axial end 75 of pump shaft 75, respectively. Referring to FIGS. 6 and 7, there are shown impellers 74 and 76, respectively, viewing their respective axially outward sides 82 and 84. It may be noted that vanes 78 curve radially inward and in a clockwise or rightward direction toward a center C₁ of impeller 74. Thus, impeller 74 has a right-handed vane configuration in the FIG. 6 illustration, and impeller 74 pumps fluid when rotated to the right, in a clockwise direction. In FIG. 7, impeller 76 is a closed impeller, and the illustration is broken to illustrate vanes 80. Vanes 80 may curve radially inward and in a counterclockwise or leftward direction toward a center C₂ of impeller 76. Impeller 76 thus includes a left-handed vane configuration and pumps fluid when rotated to the left, in a counterclockwise direction.

As mentioned above, first impeller 74 may have a first impeller configuration, which may be an open impeller configuration. Second impeller 76 may have a second, different impeller configuration which may be a closed impeller configuration. Those skilled in the art will be familiar with differences between closed impellers and open impellers. Open impellers tend to be relatively less costly to manufacture than closed impellers. Open impellers, however, tend to have a relatively high tolerance sensitivity with regard to their corresponding volute than a tolerance sensitivity associated with closed impellers. For example, it is generally desirable to position an open impeller at a relatively tight clearance with respect to its volute. Efficiency losses are associated with open impellers positioned at too great a clearance with their volute. Accordingly, performance of open impellers tends to suffer relatively more where dimensional changes or inaccuracies develop during, impeller manufacturing, pump assembly or operation of au associated pump.

Closed impellers tend to pump fluid relatively more efficiently than open impellers. While tending to be relatively more costly, closed impellers can be positioned at a relatively greater clearance with respect to their volute without negatively impacting performance. Closed impeller performance is thus relatively less sensitive to tolerance and tolerance stack-up, since a relatively larger distance range exists within which a closed impeller can be placed relative to its volute and still operate as intended. An open impeller such as impeller 74 may thus be understood to define a relatively high tolerance sensitivity, and a closed impeller such as impeller 76 may be understood to define a relatively low tolerance sensitivity. As further explained herein, pump 30 may be assembled such that first impeller 74 is positioned at a first, relatively tighter/smaller clearance with volute 48 which is based at least in part on a relatively greater tolerance sensitivity. Impeller 76 may be positioned at a second, relatively greater clearance with volute 52 which is based at least in pail on a relatively lesser tolerance sensitivity. Different axial clearances between axially outward sides 82 and 84 of impellers 74 and 76 and volutes 48 and 52, respectively, are shown in FIG. 3.

It will be recalled that bearing 59b may be an axially floating bearing. Pump 30 will typically increase in temperature once cooling system 28 begins operating. In other words, prior to start-up, pump 30 will typically be at an ambient temperature, but may increase in temperature as it begins operating. Providing some axial clearance for bearing 59b allows pump shaft 72 to change in length as its temperature increases. Impeller 74 may also be placed relatively closer to bearing 55a than impeller 76, resulting in relatively less shaft length between bearing 55a and impeller 74 that can experience thermal growth than is the case with impeller 76. Since second impeller 76 is relatively less sensitive to deviations from a specified clearance with volute 52, second impeller 76 may be allowed to move a certain amount in an axially outward direction as pump shaft 72 grows in length. By using a closed impeller for second impeller 76, extra clearance may be built into the design of pump 30 to accommodate thermal growth of certain of the components without raising concerns of significantly impacting performance of second impeller 76.

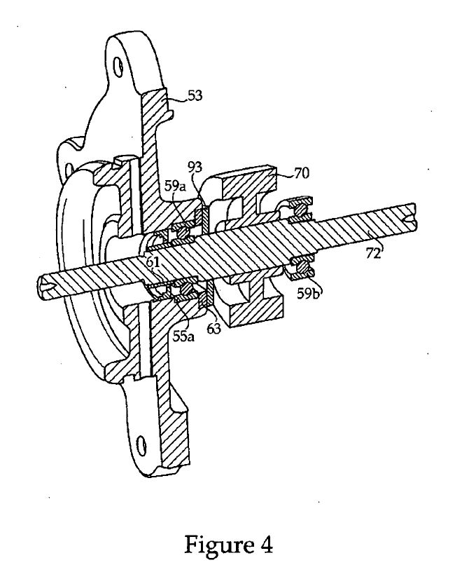

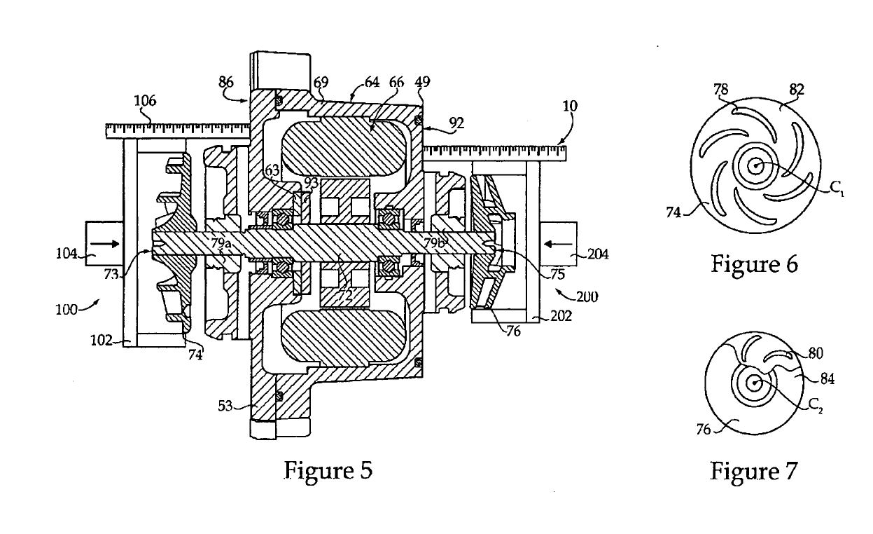

Referring also now to FIG. 4, assembly of pump 30 may include assembling pump shaft 72 with bearing housing 53, having bearing bore 55a and bearing 59a therein. In one embodiment, assembly may commence by positioning bearing 59a on pump shaft 72, for example via a press fit, then press fitting bearing sleeve 61 into abutment with bearing 59a. Bearing 59a may then be fitted within bearing bore 55a, and assembly may continue by positioning rotor 70 and bearing 59b on pump shaft 72, and placing lip seal 57a between bearing housing 53 and bearing sleeve 61. Once the subassembly shown in FIG. 4 is prepared, drive assembly 64, including motor housing 69, may be coupled with bearing housing 53. Referring also to FIG. 5, there is shown motor housing 69 coupled with bearing housing 53. Bearing housing 53 may include a first axial side 86 and a second axial side 88. Second axial side 88 may be connected with a first axial side 90 of motor housing 69 and fluidly sealed therewith. Assembly of drive assembly 64 with bearing housing 53 may take place prior to positioning impellers 74 and 76 on pump shaft 72.

In one embodiment, impeller 74 may be press fit onto pump shaft 72 in a manner which avoids problems associated with tolerance stack-up. Eliminating or minimizing tolerance stack-up when pressing impeller 74 onto pump shaft 72 enables establishing a relatively tight clearance of impeller 74 with volute 48. In particular, in FIG. 5 an assembly device 100 is shown having a clamping device 102 that clamps about impeller 74. Assembly device 100 also includes an actuator 104, which is configured for press fitting impeller 74 onto first axial end 73 of pump shaft 72. Assembly device 100 also includes a locating device 106, which contacts first side 86 of bearing housing 53 during pressing first impeller 74 onto pump shaft 72. Impeller 74 may thus be pressed to an axial location on pump shaft 72 that is controlled via the interaction of locating device 106 with first axial side 86 of bearing housing 53. By locating first impeller 74 from first axial side 86, when first housing portion 47 is subsequently connected with bearing housing 53 there are no intervening parts whose dimensional tolerances can negatively affect achieving a desired clearance and coaxial positioning of impeller 74 relative to volute 48 or otherwise impact proper positioning of components of pump 46.

It will be recalled that closed impeller 76 defines a relatively low tolerance sensitivity, and thus it is not necessary to avoid or minimize tolerance stack-up when assembling impeller 76 with pump shaft 72 as is done in the case of impeller 74. Intervening components such as motor housing 69 may affect the ability to precisely position second impeller 76. Due to the relatively low tolerance sensitivity of second impeller 76, however, deviations from specifications in positioning or dimensions of second impeller 76 and of second housing portion 51 may be less problematic than would be the case with first impeller 74 and first housing portion 47. Assembly of impeller 76 onto axial end 75 of pump shaft 72 may take place by positioning second impeller 76 in an assembly device 200, having a clamping device 202 and an actuator 204, then pressing second impeller 76 onto axial end 75 of pump shaft 72 and locating second impeller 76 during pressing via contacting a locating device 206 of assembly device 200 with second side 92 of motor housing 69. Once the components are assembled to the state depicted in FIG. 5, housing portions 47 and 51 may be coupled therewith and assembly completed.

### INDUSTRIAL APPLICABILITY

Operation of pump 30 may include energizing electric motor 66 to induce rotation of rotor 70. Pump shaft 72 will rotate in a plumping direction with rotor 70 and simultaneously rotate first impeller 74 and second impeller 76 in the pumping direction. Rotation of impellers 74 and 76 will transition fluid through volutes 48 and 52. Where used in the context of machine 10 of FIG. 1, transitioning fluid through first volute 48 will pump fluid through first cooling fluid circuit 32. Transitioning fluid through second volute 52 will plump fluid through second cooling fluid circuit 34. Fluid in first cooling circuit 32 will be passed through cooling circuit segment 42, in heat transference contact with engine 22, and thenceforth flow to radiator 38. Fluid may be returned from radiator 38 and re-enter first volute 48 and thenceforth be recirculated. Fluid in second cooling circuit 34 will be passed through cooling circuit segment 44, in heat transference contact with generator 24, and thenceforth flow to radiator 36. Fluid may be returned from radiator 36 and re-enter second volute 52 and thenceforth be recirculated.

As mentioned above, when pump 30 begins operation it may be approximately at an ambient temperature. As engine 22 and generator 24 generate heat, dissipation of heat to coolant fluid in cooling system 28 will tend to raise the temperature of pump 30. The use of a housing material having a relatively higher thermal conductivity for motor housing piece 69 and second housing portion 52 will assist in dissipating heat from fluid passing through pump 30 to ambient, and will also assist in dissipating heat generated via operating motor 66 itself. The relatively higher stiffness of the housing material of motor housing piece 69 and second housing portion 51 may also attenuate certain wear inducing vibration frequencies during pump operation. A thermal gradient may exist from motor 66 through motor housing piece 69 and into second housing portion 51. The need to dissipate heat from first housing portion 47 is contemplated to be relatively lower than the need to dissipate heat from drive assembly 64. The relatively less heat conductive housing material of first housing portion 47 and bearing housing 53, such as cast iron, can provide for robust mounting and support of pump 30 when mounted to engine 22. Increasing temperature may also result in thermal growth of pump shaft 72 in an axial direction. Since second impeller 76 is less sensitive to being located at a tight clearance with volute 52 than is first impeller 74 with volute 48, pump 30 may be designed such that second impeller 76 actually moves closer to volute 52 to accommodate thermal growth of pump shaft 72 as temperance of pump 30 rises. Axially floating bearing 59b also accommodates thermal growth of pump shaft 72. By designing bearing 59a to be axially fixed, thermal growth of pump shaft 72 may be directed predominantly in a direction of least resistance, axially outward toward second volute 52.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. For example, while the present disclosure contemplates a specific cooling fluid plumbing design, the present disclosure is not thereby limited, and additional cooling circuit segments for cooling other components of machine 10 might be added or reconfigured as compared with the design described herein. Other aspects, features and advantages will be apparent upon an examination of the attached drawings and appended claims

We claim:

1. An electrically powered pump for a cooling system in a machine comprising:
a pump housing having a first volute that includes a first cooling circuit segment and a second volute that includes a second cooling circuit segment, the pump housing further defining a longitudinal housing axis, a first fluid inlet to the pump housing and a first fluid outlet from the pump housing each fluidly connecting with the first volute, and a second fluid inlet to the pump housing and a second fluid outlet from the pump housing each fluidly connecting with the second volute;
a drive assembly including an electric motor having a stator and a rotor, and a rotatable pump shaft fixed to rotate with the rotor in a pumping direction, the stator, rotor and pump shaft having fixed axial positions within the pump housing;
a first impeller disposed in the first cooling circuit segment and mounted to the pump shaft at a first axial location on a first side of the rotor, the first impeller having a first impeller configuration and being rotatable in the pumping direction to transition fluid from the first fluid inlet to the first fluid outlet; and
a second impeller disposed in the second cooling circuit segment and mounted to the pump shaft at a second axial location on a second side of the rotor which is opposite the first side, the second impeller having a second, different impeller configuration and being rotatable in the pumping direction to transition fluid from the second fluid inlet to the second fluid outlet.

2. The pump of claim 1 wherein the first impeller defines a relatively high tolerance sensitivity with the first volute and the first impeller has a first clearance with the first volute, and wherein the second impeller defines a relatively low tolerance sensitivity with the second volute and the second impeller has a second clearance with the second volute which is larger than the first clearance.

3. The pump of claim 2 wherein the first impeller includes an open impeller and the second impeller includes a closed impeller.

4. The pump of claim 2 wherein one of the first impeller and the second impeller includes a left-handed vane configuration and the other of the first impeller and the second impeller includes a right-handed vane configuration.

5. The pump of claim 4 wherein the first impeller includes an open impeller and the second impeller includes a closed impeller.

6. The pump of claim 5 wherein the first impeller defines an axial thrust vector having a first direction and the second impeller defines another axial thrust vector having a second direction opposed to the first direction.

7. The pump of claim 6 wherein the first direction includes a first axially outward direction and the first impeller includes an axial inlet side facing the first axially outward direction, and wherein the second direction includes a second axially outward direction and the second impeller includes an axial inlet side facing the second axially outward direction.

8. The pump of claim 7 wherein the first volute includes a first volute volume and the second volute includes a second volute volume which is less than the first volute volume.

9. The pump of claim 1 wherein the pump housing includes a first housing portion in which the first volute and the first impeller are located, a second housing portion in which the second volute and the second impeller are located and a two-piece middle housing portion in which the electric motor is located, the middle housing portion further including a first bearing bore having a first bearing therein rotatably journaling the pump shaft and a second bearing bore having a second bearing therein also rotatably journaling the pump shaft.

10. The pump of claim 9 wherein the first bearing includes an axially fixed bearing positioned on the first side of the rotor and the second bearing includes an axially floating bearing positioned on the second side of the rotor, the pump further comprising a retaining ring positioned adjacent the axially fixed bearing, and an electrical grounding ring positioned axially inward of the retaining ring and electrically connecting the pump shaft with the pump housing.

11. The pump of claim 10 wherein the middle housing portion includes a bearing housing and a motor housing, wherein the first housing portion and the bearing housing include a first housing material having a relatively lower thermal conductivity and a relatively lower stiffness, and wherein the motor housing and the second housing portion include a second housing material having a relatively higher thermal conductivity and a relatively higher stiffness.

12. The pump of claim 11 wherein the first housing portion includes a mounting interface having a plurality of bolt holes for mounting the pump to an engine block of an internal combustion engine, and wherein the first fluid outlet is located within the mounting interface.

13. A cooling system for an electric drive machine comprising:
a first cooling fluid circuit including a plurality of cooling circuit segments;
a second cooling fluid circuit fluidly separate from the first cooling fluid circuit and including another plurality of cooling circuit segments; and
an electrically powered pump including a plump housing having a first volute that includes a cooling circuit segment of the first cooling fluid circuit and a second volute that includes a cooling circuit segment of the second cooling fluid circuit, the pump housing further defining a first fluid inlet to the pump housing and a first fluid outlet from the pump housing each fluidly connecting with the first volute, and a second fluid inlet to the pump housing and a second fluid outlet from the pump housing each fluidly connecting with the second volute:
the electrically powered pump further including a drive assembly that includes an electric motor and a pump shaft rotatable via the electric motor, a first impeller mounted to the pump shaft and having a first impeller configuration, and a second impeller mounted to the pump shaft and having a second, different impeller configuration.

14. The cooling system of claim 13 wherein the first cooling fluid circuit includes an engine cooling circuit segment and the second cooling fluid circuit includes a generator cooling circuit segment.

15. The cooling system of claim 14 wherein:
the pump shaft includes a longitudinal shaft axis and the first impeller is positioned at a first axial position on the pump shaft, the second impeller is positioned at a second axial position on the pump shaft and the electric motor includes a rotor coupled with the pump shaft at a third axial position between the first axial position and the second axial position; and
the first volute has a relatively larger volute volume and the second volute has a relatively smaller volute volume, the first impeller having an axial inlet side facing an axially outward direction, and the second impeller having an axial inlet side facing an opposite axially outward direction.

16. The cooling system of claim 15 wherein the first impeller includes an open impeller and the second impeller includes a closed impeller, and wherein one of the first impeller and the second impeller includes a right-handed vane configuration and the other of the first impeller and the second impeller includes a left-handed vane configuration.

17. A method of assembling an electrically powered pump for a cooling system in a machine comprising:
assembling a pump shaft having a longitudinal shaft axis with a bearing housing that includes a bearing bore therein and a pump shaft bearing positioned within the bearing bore;
locating a first impeller having a first impeller configuration at a first axial position on the pump shaft at least in part via contacting a first axial side of the bearing housing with a locating device during pressing the first impeller onto the pump shaft;
coupling a drive assembly with the pump shaft, including connecting a first axial side of an electrical motor housing of the drive assembly with a second axial side of the bearing housing; and
locating a second impeller having a second, different impeller configuration at a second axial position on the pump shaft at least in part via contacting a second axial side of the electrical motor housing with a locating device during pressing the second impeller onto the pump shaft.

18. The method of claim 17 further comprising positioning the first impeller at a first clearance with a first volute of the pump housing which is based at least in part on a relatively high tolerance sensitivity defined by the first impeller, and positioning the second impeller at a second, relatively greater clearance with a second volute of the pump housing which is based at least in part on a relatively low tolerance sensitivity defined by the second impeller.

19. The method of claim 18 wherein locating a first impeller includes locating an open impeller on the pump shaft, and wherein locating a second impeller includes locating a closed impeller on the pump shaft.

20. The method of claim 19 further comprising rotatably journaling the pump shaft via an axially floating bearing positioned in a bearing bore in the electrical motor housing on a first axial side of a rotor of the drive assembly and via an axially fixed bearing positioned in the bearing bore of the bearing housing on a second axial side of the rotor of the drive assembly.

21. An electrically powered pump for a cooling system in a machine comprising:
a fluid pumping mechanism including a drive assembly having an electric motor and a pump shaft rotatably coupled with the electric motor and including a first axial end and a second axial end, the fluid pumping mechanism further including a first impeller mounted to the pump shaft adjacent the first axial end and a second impeller mounted to the pump shaft adjacent the second axial end; and
a pump housing including an outer surface, a first volute positioned about the first impeller and including a first cooling circuit segment and a second volute positioned about the second impeller and including a second cooling circuit segment, the pump housing further including a two-piece motor housing which contains the electric motor and is positioned between the first volute and the second volute and arranged coaxially about the pump shaft, the two-piece motor housing having a first motor housing piece and a second motor housing piece mated with the first motor housing piece and each including a portion of the outer surface of the pump housing,
wherein the first motor housing piece includes a first axially inward segment defining a first bearing bore having a first pump shaft journal bearing positioned therein and a first axially outward segment projecting into the first volute and defining a first water seal bore having a first water seal positioned therein; and
wherein the second motor housing piece includes a second axially inward segment defining a second bearing bore having a second pump shaft journal bearing positioned therein and a second axially outward segment projecting into the second volute and defining a second water seal bore having a second water seal positioned therein.

22. The electrically powered pump of claim 21 wherein:
the pump housing defines a first weep collection chamber located between the first volute and the first motor housing piece and defines a second weep collection chamber located between the second volute and the second motor housing piece; and
the first motor housing piece defines a first drain passage communicating between the first water seal bore and the first weep collection chamber, and wherein the second motor housing piece defines a second drain passage communicating between the second water seal bore and the second weep collection chamber.
